(19) United States
(12) Patent Application Publication
(10) Pub. No.: US 2025/0261190 A1
(43) Pub. Date: Aug. 14, 2025

(54) SYSTEM INFORMATION TRANSMISSION METHOD AND APPARATUS, COMMUNICATION DEVICE, AND STORAGE MEDIUM

(71) Applicant: BEIJING XIAOMI MOBILE SOFTWARE CO., LTD., Beijing (CN)

(72) Inventor: Ting FU, Beijing (CN)

(73) Assignee: BEIJING XIAOMI MOBILE SOFTWARE CO., LTD., Beijing (CN)

(21) Appl. No.: 18/857,258

(22) PCT Filed: Apr. 29, 2022
(86) PCT No.: PCT/CN2022/090650

§ 371 Date: Oct. 16, 2024

(51) Int. Cl. H04W 72/1268; H04W 28/26; H04W 72/231; H04W 72/30

(52) U.S. Cl. CPC H04W 72/1268; H04W 28/26; H04W 72/231; H04W 72/30

(57) ABSTRACT

Embodiments of the present disclosure provide a system information (SI) transmission method and apparatus, a communication device, and a storage medium. The SI transmission method is executed by a base station, and includes: transmitting SI, wherein at least two SIBs are configured in one piece of SI, and at least one piece of feature information of the at least two SIBs is different.

### CROSS-REFERENCE

The present application is a U.S. National Stage of International Application No. PCT/CN2022/090650, filed on Apr. 29, 2022, the content of which is incorporated herein by reference in its entirety for all purposes.

### TECHNICAL FIELD

The present disclosure relates to, but is not limited to, the field of wireless communication technologies, and in particular to a method and apparatus for transmitting system information, a communication device and a storage medium.

### BACKGROUND

In New Radio (NR) systems, one System Information (SI) can include one or more System Information Blocks (SIBs). However, multiple SIBs that can be placed in the same SI need to have the same transmission period and the same broadcast state.

### SUMMARY

Embodiments of the present disclosure disclose a method and apparatus for transmitting system information, a communication device and a storage medium.

According to a first aspect of the present disclosure, there is provided a method for transmitting system information, which is performed by a base station and includes:
sending a System Information (SI), wherein at least two System Information Blocks (SIBs) are configured in one SI, and wherein at least one piece of characteristic information of the at least two SIBs is different.

According to a second aspect of the present disclosure, there is provided a method for transmitting system information, which is performed by a UE and includes:
receiving a SI, wherein at least two SIBs are configured in one SI, and wherein at least one piece of characteristic information of the at least two SIBs is different.

According to a third aspect of the present disclosure, there is provided a communication device, including:
a processor; and
a memory configured to store executable instructions of the processor;
wherein the processor is configured to implement the method for transmitting the system information in any embodiment of the present disclosure when running the executable instructions.

According to a fourth aspect of the present disclosure, there is provided a computer storage medium having a computer executable program stored thereon, which, when executed by a processor, implements the method for transmitting the system information in any embodiment of the present disclosure.

It should be noted that the above general description and the following detailed description are merely exemplary and explanatory and should not be construed as limiting of embodiments of the present disclosure.

### BRIEF DESCRIPTION OF THE DRAWINGS

FIG. 1 shows a schematic structural diagram of a wireless communication system according to an embodiment of the present disclosure;

FIG. 2 shows a flowchart of a method for transmitting system information according to an embodiment of the present disclosure;

FIG. 3 shows a flowchart of a method for transmitting system information according to an embodiment of the present disclosure;

FIG. 4 shows a flowchart of a method for transmitting system information according to an embodiment of the present disclosure;

FIG. 5 shows a flowchart of a method for transmitting system information according to an embodiment of the present disclosure;

FIG. 6 shows a flowchart of a method for transmitting system information according to an embodiment of the present disclosure;

FIG. 7 shows a flowchart of a method for transmitting system information according to an embodiment of the present disclosure;

FIG. 8 shows a block diagram of an apparatus for transmitting system information according to an embodiment of the present disclosure;

FIG. 9 shows a block diagram of an apparatus for transmitting system information according to an embodiment of the present disclosure;

FIG. 10 shows a block diagram of a UE according to an embodiment of the present disclosure; and

FIG. 11 shows a block diagram of a base station according to an embodiment of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of the embodiments do not represent all implementations consistent with the present disclosure. Instead, they are merely examples of apparatuses and methods consistent with some aspects of the embodiments of the present disclosure as recited in the appended claims.

The terms used in the embodiments of the present disclosure are merely for the purpose of describing particular embodiments and are not intended to limit the embodiments of the present disclosure. As used in the present disclosure and the appended claims, the singular forms “a” and “the” are intended to include the plural forms as well, unless the context clearly indicates otherwise. It should also be understood that the term “and/or” as used herein refers to and includes any or all possible combinations of one or more of the associated listed items.

It should be understood that, although the terms first, second, third, etc. may be used in embodiments of the present disclosure to describe various information, such information should not be limited to these terms. These terms are only used to distinguish the same type of information from each other. For example, without departing from the scope of embodiments of the present disclosure, first information may also be referred to as second information, and similarly, the second information may also be referred to as the first information. Depending on the context, the word “if” as used herein can be interpreted as “upon” or “when” or “in response to determination”.

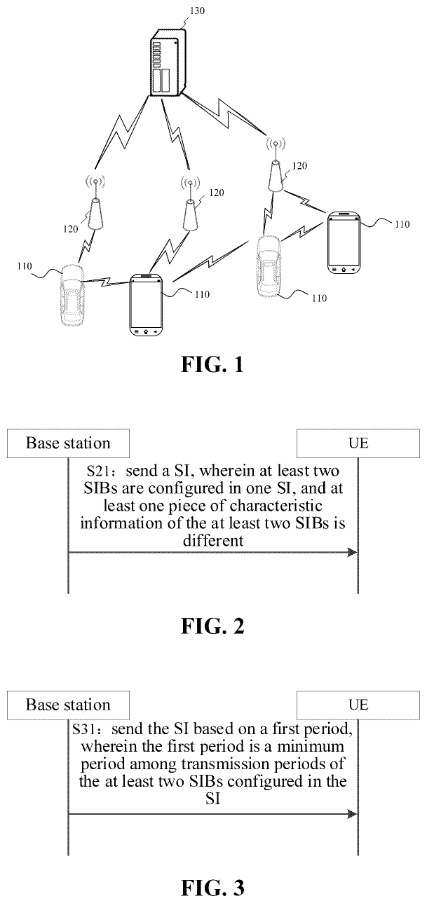

Reference is made to FIG. 1, which shows a schematic structural diagram of a wireless communication system provided by an embodiment of the present disclosure. As illustrated in FIG. 1, the wireless communication system is a communication system based on cellar mobile communication technologies. The wireless communication system may include several User Equipments (UEs) 110 and several base stations 120.

The UE 110 may refer to a device that provides voice and/or data connectivity to a user. The UE 110 may communicate with one or more core networks via a Radio Access Network (RAN). The UE 110 may be an Internet of Things UE, such as a sensor device, a mobile phone (or called “cellular” phone) and a computer with the Internet of Things UE, for example, may be a fixed, portable, pocket-sized, handheld, built-in computer or vehicle-mounted device. For example, the UE may be a station (STA), a subscriber unit, a subscriber station, a mobile station, a mobile, a remote station, an access point, a remote terminal, an access terminal, a user terminal, a user agent, a user device, or user equipment. Or, the UE 110 may also be a device of an unmanned aerial vehicle. Or, the UE 110 may also be a vehicle-mounted device, such as a trip computer with a wireless communication function, or a wireless user device connected to an external trip computer. Or, the UE 110 may also be a roadside device, such as a streetlight, a signal light or another roadside device with a wireless communication function.

The base station 120 can be a network-side device in a wireless communication system. The wireless communication system can be a 4th generation mobile communication (4G) system, also known as a Long Term Evolution (LTE) system. Or, the wireless communication system may also be a 5G system, also known as a New Radio (NR) system or a 5G NR system. Or, the wireless communication system may also be a next-generation system of 5G system. An access network in the 5G system can be referred to as a New Generation-Radio Access Network (NG-RAN).

The base station 120 can be an evolved NodeB (eNB) in the 4G system. Or, the base station 120 may also be a gNB with a central distributed architecture in the 5G system. When the base station 120 adopts the central distributed architecture, it usually includes a Central Unit (CU) and at least two Distributed Units (DUs). The CU is provided with a protocol stack of a Packet Data Convergence Protocol (PDCP) layer, a Radio Link Control (RLC) layer, and a Media Access Control (MAC) layer. The DU is provided with a protocol stack of a Physical (PHY) layer. A specific implementation of the base station 120 is not limited in embodiments of the present disclosure.

A wireless connection can be established between the base station 120 and the UE 110 through a radio air interface. In different implementations, the radio air interface is a radio air interface based on a 4th generation mobile communication network technology (4G) standard. Or, the radio air interface is a radio air interface based on a 5th generation mobile communication network technology (5G) standard, such as the NR. Or, the radio air interface may also be a radio air interface based on a 5G next-generation mobile communication network technology standard.

In some embodiments, an End to End (E2E) connection may also be established between UEs 110, such as a vehicle to vehicle (V2V) communication, a vehicle to infrastructure (V2I) communication and a vehicle to pedestrian (V2P) communication in a vehicle to everything (V2X) communication, and other scenarios.

Here, the above UE may also be considered to be a terminal device in the following embodiments.

In some embodiments, the above wireless communication system may further include a network management device 130.

The several base stations 120 are connected to the network management device 130, respectively. The network management device 130 can be a core network device in the wireless communication system. For example, the network management device 130 can be a Mobility Management Entity (MME) in an Evolved Packet Core (EPC) network. Or, the network management device may also be another core network device, such as a Serving Gateway (SGW), a Public Data Network Gateway (PGW), a Policy and Charging Rules Function (PCRF) unit or a Home Subscriber Server (HSS). An implementation form of the network management device 130 is not limited in embodiments of the present disclosure.

In order to facilitate the understanding of those skilled in the art, embodiments of the present disclosure enumerate multiple implementations to clearly illustrate the technical solutions of the embodiments of the present disclosure. Note that, those skilled in the art can understand that the multiple embodiments provided by the embodiments of the present disclosure can be executed separately, or can be executed together with the methods of other embodiments of the embodiments of the present disclosure, or can be executed together with some methods in other related arts separately or in combination; the embodiments of the present disclosure do not limit this.

As described above, in New Radio (NR) systems, one System Information (SI) can include one or more System Information Blocks (SIBs). However, multiple SIBs that can be placed in the same SI need to have the same transmission period and the same broadcast state. At present, SIBs with different transmission periods and/or broadcast states cannot be placed in the same SI, which will require multiple SIs to send the SIBs with different transmission periods and/or broadcast states, resulting in relatively high power consumption of a network device, etc.

In order to better understand the technical solution described in any embodiment of the present disclosure, first, the transmission of the system information in the related art is partially explained.

In an embodiment, one SI includes one or more SIBs. If one SI includes multiple SIBs, the multiple SIBs have the same transmission period and the same broadcast state. In the communication protocol, the base station broadcasts the system information in SI as the smallest unit, that is, when the SI is broadcast, all SIBs included in the SI need to be broadcast simultaneously.

In an embodiment, the base station schedules, through Downlink Control Information (DCI) scrambled by a System Information Radio Network Temporary Identity (SI-RNTI), a Physical Downlink Shared Channel (PDSCH) carrying the SI. Here, when the base station broadcasts the SI, it is required that a Physical Downlink Control Channel (PDCCH) for the SI scheduling and/or the PDSCH carrying the SI are broadcast on a Synchronization Signal Block (SSB) beam actually sent by the base station, and this broadcasting manner may be called a beam sweeping manner.

In an embodiment, the system information is classified as a broadcast state or a non-broadcast state according to its broadcast state. The broadcast state is that the base station actively broadcasts according to a transmission period of the SI. The non-broadcast state is that the base station does not actively broadcast, and if the UE needs to obtain the system information, it needs to initiate a request, after receiving the request, the base station sends the requested system information to the terminal by broadcast or unicast.

In an embodiment, the R18 network energy saving project aims to study the reduction of the energy consumption of the base station. A way to reduce the energy consumption of the base station may be to reduce an unnecessary broadcast signal.

As shown in FIG. 2, embodiments of the present disclosure provide a method for transmitting system information, which is performed by a base station and includes:

in step S21, a SI is sent, at least two SIBs are configured in one SI, and at least one piece of characteristic information of the at least two SIBs is different.

Here, the base station may be various types of base stations, which may be, for example, a 2G base station, a 3G base station, a 4G base station, a 5G base station or other evolved base stations.

In some embodiments of the present disclosure, the method for transmitting the system information may also be performed by a network device, and the network device may be a core network device or an access network device. The core network device may be, but is not limited to, various entities or network element functions of the core network. The access network device may be the base station in the above embodiments. If the method for transmitting the system information is performed by the core network device, then it may be: the core network device sends the SI to the base station, and the base station forwards the SI to the UE.

In an embodiment, sending the SI in the step S21 includes: sending the SI to the UE.

Here, the UE may be various mobile terminals or fixed terminals. For example, the UE may be but is not limited to, a mobile phone, a computer, a server, a wearable device, a game control platform, or a multimedia device. For example, the UE may be a RedCap UE, a 5G NR-lite UE or the like.

Embodiments of the present disclosure provide a method for transmitting system information, which is performed by a network device, and includes configuring at least two SIBs for one SI, and at least one piece of characteristic information of the at least two SIBs is different.

In some embodiments, the characteristic information includes at least one of:
period information of a SIB transmission period;
state information of a SIB broadcast state, and the state information includes broadcast state information or non-broadcast state information.

Here, the broadcast state information is configured to indicate the broadcast state, and the non-broadcast state information is configured to indicate the non-broadcast state.

Embodiments of the present disclosure provide a method for transmitting system information, which is performed by a base station, and includes: sending SI, at least two SIBs are configured in one SI, and period information of the at least two SIBs is different.

For example, the base station sends the SI to the UE, two SIBs are configured in one SI, and transmission periods of the two SIBs are different.

For example, the base station sends the SI to the UE, three SIBs are configured in one SI, and the three SIBs may be SIB1, SIB2 and SIB3, respectively. Transmission periods of SIB1 and SIB2 are transmission period 1, a transmission period of SIB3 is transmission period 2, and transmission period 1 is different from transmission period 2.

Embodiments of the present disclosure provide a method for transmitting system information, which is performed by a base station, and includes: sending SI, at least two SIBs are configured in one SI, and state information of the at least two SIBs is different.

For example, the base station sends the SI to the UE, two SIBs are configured in one SI, the two SIBs may be SIB1 and SIB2, respectively, and SIB1 is in the broadcast state, and SIB2 is in the non-broadcast state.

For example, the base station sends the SI to the UE, three SIBs are configured in one SI, the three SIBs may be SIB1, SIB2 and SIB3, respectively, and SIB1 is in the broadcast state, SIB2 and SIB3 are in the non-broadcast state.

Embodiments of the present disclosure provide a method for transmitting system information, which is performed by a base station, and includes: sending SI, at least two SIBs are configured in one SI, and period information and state information of the at least two SIBs are different.

For example, the base station sends the SI to the UE, two SIBs are configured in one SI, the two SIBs may be SIB1 and SIB2, respectively, and transmission periods of SIB1 and SIB2 are different and the broadcast states of SIB1 and SIB2 are different. For example, the transmission period of SIB1 is period 1, the transmission period of SIB2 is period 2, and period 1 is different from period 2, and furthermore, SIB1 is in the broadcast state, and SIB2 is in the non-broadcast state.

For example, the base station sends the SI to the UE, three SIBs are configured in one SI, and the three SIBs may be SIB1, SIB2, and SIB3, respectively. The transmission periods of SIB1, SIB2, and SIB3 may be transmission period 1, transmission period 2, and transmission period 3, respectively, the broadcast states of SIB1, SIB2, and SIB3 may be the broadcast state, the broadcast state, and the non-broadcast state, respectively. The transmission period 1, the transmission period 2, and the transmission period 3 are all different.

It should be understood that “different” in embodiments of the present disclosure can be understood as not completely the same. That is, for any piece of characteristic information, multiple SIBs can be different from each other, or at least one pair of SIBs can be different while the other SIBs are the same.

In this way, the base station can configure SIBs with different transmission periods and/or different states in the same SI for transmission. Compared with configuring the SIBs with different transmission periods and/or different states in different SIs for transmission, the transmission of SI can be greatly reduced, thereby reducing the energy consumption of the base station and the UE.

In some embodiments, the SIB includes at least one of:
a predetermined SIB;
SIB N, where N is a positive integer; and
a SIB other than SIB 1 to SIB 21 and SIBpos.

For example, the predetermined SIB may be a SIB of a new version, such as a SIB newly defined in R18 or R19, etc. For another example, the predetermined SIB may be a SIB for a certain function, and the certain function may be any function that can be realized.

For example, the SIB N may be SIB 22.

For example, the SIB other than SIB 1 to SIB 21 and SIBpos may be any SIB of other SIB X except SIB1 to SIB21 and SIBpos. For example, X in the SIB X is an integer greater than 21. Alternatively, the SIB other than SIB 1 to SIB 21 and SIBpos may be any SIB of a predetermined function except the positioning function, and the SIBpos is a SIB for the positioning function.

In other embodiments, the SIB involved may be any newly defined SIB, or a SIB modified based on the existing protocol, etc.

In embodiments of the present disclosure, the SI can be sent, the at least two SIBs are configured in one SI, and the at least one piece of characteristic information of the at least two SIBs is different. Thus, compared with the prior art, in the embodiments of the present disclosure, the at least two SIBs with different characteristic information are not required to be sent through at least two SIs, but can be sent through only one SI. In this way, the sending of SI can be reduced, thereby reducing the energy consumption of the base station.

It should be noted that those skilled in the art can understand that the method provided in embodiments of the present disclosure can be executed alone or together with some methods in the embodiments of the present disclosure or some methods in the related arts.

In some embodiments, sending the System Information (SI) in the step S21 includes:
sending the SI based on a first period, and the first period is the minimum period among transmission periods of the at least two SIBs configured in the SI.

As shown in FIG. 3, embodiments of the present disclosure provide a method for transmitting system information, which is performed by a base station and includes:
in step S31, the SI is sent based on a first period, and the first period is the minimum period among transmission periods of the at least two SIBs configured in the SI.

For example, the at least two SIBs configured in one SI by the base station are SIB1, SIB2 and SIB3, respectively, transmission periods of SIB1, SIB2 and SIB3 are transmission period 1, transmission period 2 and transmission period 3, respectively, and transmission period 1 is less than transmission period 2, and transmission period 1 is less than transmission period 3. Then the base station determines that the transmission period for sending the SI is transmission period 1, and sends the SI based on the period of transmission period 1.

In some embodiments, a transmission period of any one of the at least two SIBs configured in the SI is a first multiple of the minimum period, and the first multiple is an integer greater than 0.

For example, the base station configures three SIBs in one SI, which are SIB1, SIB2 and SIB3, respectively. The transmission period 1 of SIB1 is the minimum period, i.e., the first period, and the transmission period 2 of SIB2 may be 2 times the first period, the transmission period 3 of SIB3 is 4 times the first period.

Thus, in embodiments of the present disclosure, the base station may send the SI through the minimum period among transmission periods of the at least two SIBs configured in the SI, so that all SIBs in the SI can be sent periodically according to a period configuration of this SIB.

It should be noted that those skilled in the art can understand that the method provided in embodiments of the present disclosure can be executed alone or together with some methods in the embodiments of the present disclosure or some methods in the related arts.

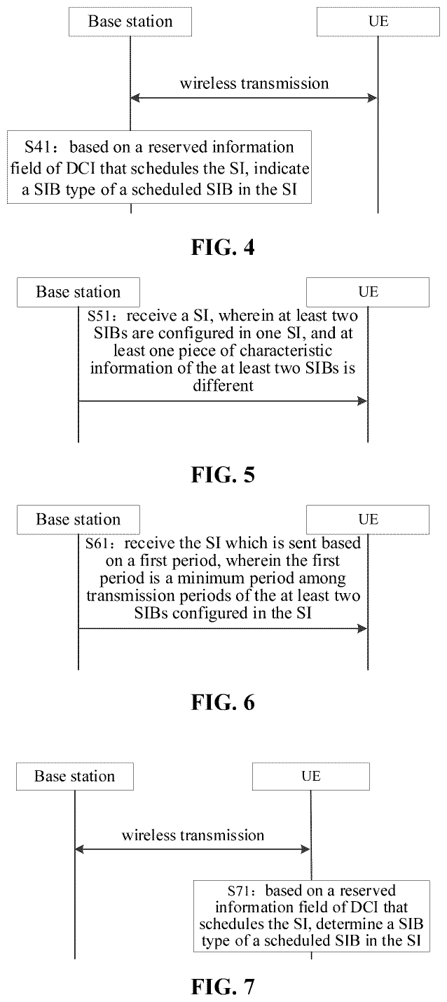

As shown in FIG. 4, embodiments of the present disclosure provide a method for transmitting system information, which is performed by a base station and includes:
in step S41, based on a reserved information field of DCI that schedules the SI, a SIB type of a scheduled SIB in the SI is indicated.

In some embodiments, the reserved information field of the DCI that schedules the SI indicates the SIB type of the scheduled SIB in the SI. Here, the SIB type of the scheduled SIB in the SI refers to a SIB type of the actually scheduled SIB in the SI.

In embodiments of the present disclosure, the SIB type of the scheduled SIB in the SI is the scheduled SIB in the SI.

In some other embodiments, the reserved information field of the DCI that schedules the SI indicates whether multiple SIBs configured in the SI are actually scheduled. In some embodiments of the present disclosure, multiple refers to two or more.

In some embodiments of the present disclosure, the SIB being scheduled means that the SIB is actually scheduled, and the SIB being unscheduled means that the SIB is not actually scheduled. A scheduling status of the SIB type refers to an actual scheduling status of the SIB type.

In some embodiments, a bit in the reserved information field is configured to indicate a scheduling status of at least one SIB type.

Here, the scheduling status of the SIB type indicated by the bit of the reserved information field of the DCI may be for SIBs with different transmission periods. Here, the reserved information field of the DCI includes at least one bit.

Here, the reserved information field may be any reserved information field in the DCI, which is not limited here. The bit of the reserved information field may be any one or more bits in the reserved information field, which is not limited here.

Here, the DCI that schedules the SI may be any DCI. For example, the DCI may be DCI 1-0, and DCI 1-0 may be scrambled by SI-RNTI; there is no limitation on the type or format of the DCI.

For example, the reserved information field of the DCI includes 2 bits, one of which indicates the scheduling status of one SIB type or the other one indicates the scheduling status of two SIB types.

For example, the reserved information field of the DCI includes 2 bits, one of which indicates the scheduling status of two SIB types or the other one indicates the scheduling status of two SIB types.

Here, when one bit indicates the scheduling status of multiple SIB types, the multiple SIB types may be multiple SIB types with consecutive numbers, or multiple SIB types with discontinuous numbers. For example, one bit may indicate three consecutive SIB types, SIB 22, SIB 23, and SIB 24; or one bit may indicate two discontinuous SIB types, SIB22 and SIB25. In embodiments of the present disclosure, multiple refers to two or more.

In some embodiments, the bit carries first indication information to indicate that the SIB type is scheduled, or the bit carries second indication information to indicate that the SIB type is not scheduled.

Here, the SIB type is scheduled, that is, the SIB type is broadcast; and the SIB type is in the broadcast state. And/or, the SIB type is not scheduled, that is, the SIB type is not broadcast; and the SIB type is in the non-broadcast state.

Here, the first indication information may be “0” or “00” or the like, and/or the second indication information may be “1” or “11” or the like.

For example, the base station configures 4 SIBs for one SI, and the 4 SIBs may be SIB 22, SIB 23, SIB 24 and SIB 25, respectively. There are 4 bits in the reserved information field of DCI 1-0, which are configured to indicate the SIB type actually transmitted in the scheduled SI, and one bit indicates a scheduling status of one SIB type. If the 4 bits are “1100”, it indicates that SIB22 and SIB23 are scheduled, and indicates that SIB24 and SIB 25 are not scheduled.

For example, the base station configures 4 SIBs for one SI, and the 4 SIBs may be SIB 22, SIB 23, SIB 24 and SIB 25, respectively. There are 2 bits in the reserved information field of DCI 1-0, which are configured to indicate the SIB type actually transmitted in the scheduled SI, and one bit indicates a scheduling status of two SIB types. If the two bits are “10”, it indicates that SIB22 and SIB23 are scheduled, and SIB24 and SIB 25 are not scheduled.

Thus, in embodiments of the present disclosure, the reserved indication field of the DCI can be used to indicate whether different types of SIBs are scheduled, so that the UE accurately knows which SIB types are transmitted and which SIB types are not transmitted. In addition, when one bit of the reserved indication field indicates a scheduling status of multiple SIB types, the overhead of the DCI bit can also be saved, thereby further saving the transmission resource between the base station and the UE and reducing the energy consumption.

Embodiments of the present disclosure provide a method for transmitting system information, which is performed by a base station and includes: sending DCI, and an information field of the DCI is configured to indicate a scheduling status of e a SIB configured in the SI.

In this way, by sending the DCI message, the UE can accurately know which SIBs among SIBs configured in the SI are transmitted or which SIBs among SIBs configured in the SI are not transmitted.

It should be noted that those skilled in the art can understand that the method provided in embodiments of the present disclosure can be executed alone or together with some methods in the embodiments of the present disclosure or some methods in the related arts.

A method for transmitting system information in the following is performed by the UE, which is similar to the description of the method for transmitting the system information performed by the base station above. For technical details not disclosed in the embodiments of the method for transmitting the system information performed by the UE, reference may be made to the description of the example of the method for transmitting the system information performed by the base station, and no detailed description is given here.

As shown in FIG. 5, embodiments of the present disclosure provide a method for transmitting system information, which is performed by a UE and includes:
in step S51, a SI is received, at least two SIBs are configured in one SI, and at least one piece of characteristic information of the at least two SIBs is different.

In some embodiments of the present disclosure, the SI may be the SI in the step S21, the SIB may be the SIB in the step S21, and the characteristic information may be the characteristic information in the step S21.

In an embodiment, the step S51 may be: receiving the SI sent by a base station.

For example, the characteristic information includes but is not limited to at least one of:
period information of a SIB transmission period; or
state information of a SIB broadcast state, wherein the state information includes: broadcast state information or non-broadcast state information.

For example, the UE receives the SI sent by the base station, and determines, based on period information of two SIBs configured in the SI, that transmission periods of the two SIBs are different. For example, the two SIBs may be SIB1 and SIB2, respectively, the transmission period of SIB1 is transmission period 1, the transmission period of SIB2 is transmission period 2, and the transmission period 1 and the transmission period 2 are different.

For example, the UE receives the SI sent by the base station, and determines, based on state information of three SIBs configured in the SI, that broadcast states of some SIBs among the three SIBs are different. For example, the three SIBs may be SIB1, SIB2 and SIB3, respectively, SIB1 is in the broadcast state, and SIB2 and SIB3 are in the non-broadcast state.

For another example, the SIB includes but is not limited to at least one of:
a predetermined SIB;
SIB N, where N is a positive integer; and
a SIB other than SIB 1 to SIB 21 and SIBpos.

For example, the predetermined SIB may be a SIB of a new version, such as a SIB newly defined in R18 or R19, etc. For another example, the predetermined SIB may be a SIB for a certain function, and the certain function may be any function that can be realized.

For example, the SIB N may be SIB 22.

For example, the SIB other than SIB 1 to SIB 21 and SIBpos may be any SIB of other SIB X except SIB1 to SIB21 and SIBpos. For example, X in the SIB X is an integer greater than 21. Alternatively, the SIB other than SIB 1 to SIB 21 and SIBpos may be any SIB of a predetermined function except the positioning function, and the SIBpos is a SIB for the positioning function.

Embodiments of the present disclosure provide a method for transmitting system information, which is performed by a UE, and includes: receiving SI, at least two SIBs are configured in one SI, and period information of the at least two SIBs is different.

Embodiments of the present disclosure provide a method for transmitting system information, which is performed by a UE, and includes: receiving SI, at least two SIBs are configured in one SI, and broadcast states of the at least two SIBs are different.

Embodiments of the present disclosure provide a method for transmitting system information, which is performed by a UE, and includes: receiving SI, at least two SIBs are configured in one SI, and period information and state information of the at least two SIBs are different.

Thus, in embodiments of the present disclosure, the UE can receive the SI sent by the base station which is configured with the at least two SIBs of different characteristic information. In this way, the at least two SIBs with different characteristic information do not need to be sent through at least two SIs, but can be sent through only one SI; then the UE can also determine the at least two SIBs with different characteristic information by only receiving one SI. Therefore, the sending of the SI by the base station and the receiving of the SI by the UE can be reduced, thereby reducing the energy consumption of the base station and the UE.

In some embodiments of the present disclosure, the implementation of the step S51 is similar to the description of the implementation of the step S21 on the base station side. For the implementation of the step S51, reference may be specifically made to the description on the base station side, which will not be repeated here.

In some embodiments, receiving the system information in the step S51 includes:
receiving the SI which is sent based on a first period, and the first period is the minimum period among transmission periods of the at least two SIBs configured in the SI.

As shown in FIG. 6, embodiments of the present disclosure provide a method for transmitting system information, which is performed by a UE and includes:
in step S61, the SI which is sent based on a first period is received, and the first period is the minimum period among transmission periods of the at least two SIBs configured in the SI.

In some embodiments, a transmission period of any one of the at least two SIBs configured in the SI is a first multiple of the minimum period, and the first multiple is an integer greater than 0.

In an embodiment, the step S61 may be receiving the SI which is sent by the base station based on the first period.

For example, the at least two SIBs configured in the SI are SIB1, SIB2 and SIB3, respectively, the transmission periods of SIB1, SIB2 and SIB3 are transmission period 1, transmission period 2 and transmission period 3, respectively; transmission period 1 is less than transmission period 2, and transmission period 1 is less than transmission period 3. Then the base station determines that the transmission period for sending the SI is the transmission period 1, and sends the SI based on the period of transmission period 1.

For example, in the above embodiments, the transmission period 1 of SIB1 is the minimum period, i.e., the first period, and the transmission period 2 of SIB2 may be 2 times the first period, the transmission period 3 of SIB3 is 4 times the first period.

Thus, in embodiments of the present disclosure, the base station may send the SI through the minimum period among transmission periods of the at least two SIBs configured in the SI, so that all SIBs in the SI can be sent periodically according to a period configuration of this SIB.

In some embodiments of the present disclosure, the implementation of the step S61 is similar to the description of the implementation of the step S31 on the base station side. For the implementation of the step S61, reference may be specifically made to the description on the base station side, which will not be repeated here.

As shown in FIG. 7, embodiments of the present disclosure provide a method for transmitting system information, which is performed by a UE and includes:
in step S71, based on a reserved information field of DCI that schedules the SI, a SIB type of a scheduled SIB in the SI is determined.

Embodiments of the present disclosure provide a method for transmitting system information, which is performed by a UE and includes:
receiving DCI that schedules the SI; and
determining, based on the reserved information field of the DCI, the SIB type of the scheduled SIB in the SI.

Here, the reserved information field may be any reserved information field in the DCI, which is not limited here. The bit of the reserved information field may be any one or more bits in the reserved information field, which is not limited here.

Here, the DCI that schedules the SI may be any DCI. For example, the DCI may be DCI 1-0, and DCI 1-0 may be scrambled by SI-RNTI; there is no limitation on the type or format of the DCI.

For example, the reserved information field of the DCI includes 2 bits, one of which indicates the scheduling status of one SIB type or the other one indicates the scheduling status of two SIB types.

For example, the reserved information field of the DCI includes 2 bits, one of which indicates the scheduling status of two SIB types or the other one indicates the scheduling status of two SIB types.

In some embodiments, a bit in the reserved information field is configured to indicate a scheduling status of at least one SIB type.

In some embodiments, the step S51 includes:
in response to the bit of the reserved information field carrying first indication information, determining that a SIB type indicated by the bit is scheduled;
or,
in response to the bit of the reserved information field carrying second indication information, determining that the SIB type indicated by the bit is not scheduled.

Embodiments of the present disclosure provide a method for transmitting system information, which is performed by a UE and includes:
in response to the bit of the reserved information field carrying first indication information, determining that a SIB type indicated by the bit is scheduled;
or,
in response to the bit of the reserved information field carrying second indication information, determining that the SIB type indicated by the bit is not scheduled.

For example, the UE receives one SI sent by the base station, and the SI is configured with 4 SIBs, which may be SIB 22, SIB 23, SIB 24 and SIB 25, respectively. There are 4 bits in the reserved information field of DCI 1-0, which are configured to indicate the SIB type actually transmitted in the scheduled SI, and one bit indicates a scheduling status of one SIB type. If the 4 bits are “1100”, it indicates that SIB22 and SIB23 are scheduled, and indicates that SIB24 and SIB 25 are not scheduled.

For example, the UE receives one SI sent by the base station and the SI is configured with 4 SIBs, which may be SIB 22, SIB 23, SIB 24 and SIB 25, respectively. There are 2 bits in the reserved information field of DCI 1-0, which are configured to indicate the SIB type actually transmitted in the scheduled SI, and one bit indicates a scheduling status of two SIB types. If the two bits are “10”, it indicates that SIB22 and SIB23 are scheduled, and SIB24 and SIB 25 are not scheduled.

Here, the UE can obtain a mapping relationship between each piece of indication information and whether the SIB type is scheduled. For example, the UE can obtain the mapping relationship from the base station or from the wireless communication protocol. For example, the mapping relationship may be that the first indication information corresponds to being scheduled; and/or the second indication information corresponds to not being scheduled. The mapping relationship may also be: a first predetermined bit of the reserved information field carrying the first indication information corresponds to a first SIB type being scheduled; and/or the first predetermined bit of the reserved information field carrying the second indication information corresponds to the first SIB type not being scheduled; and/or a second predetermined bit of the reserved information field carrying the first indication information corresponds to the second SIB type being scheduled; and/or the second predetermined bit of the reserved information field carrying the second indication information corresponds to the second SIB type not being scheduled. Here, the mapping relationship can be: different bits in the reserved information field correspond to different SIB types; and/or the bits carrying different indication information correspond to whether the SIB type is scheduled.

Thus, in embodiments of the present disclosure, the UE can accurately determine whether each SIB type is scheduled by receiving the indication information carried in the reserved information field of the DCI that schedules the SI.

In some embodiments of the present disclosure, the implementation of the step S71 is similar to the description of the implementation of the step S41 on the base station side. For the implementation of the step S71, reference may be specifically made to the description on the base station side, which will not be repeated here.

For the above implementations, reference may be specifically made to the description of the base station side, which will not be described in detail here.

It should be noted that those skilled in the art can understand that the method provided in embodiments of the present disclosure can be executed alone or together with some methods in the embodiments of the present disclosure or some methods in the related arts.

In order to further explain any embodiment of the present disclosure, a specific embodiment is provided below.

### EXAMPLE 1

Embodiments of the present disclosure provide a method for transmitting system information, which is performed by a communication device, and the communication device includes a base station and a UE. The method includes steps S81 to S83.

In the step S81, the base station configures at least two SIBs for one SI, and period information of transmission periods of the at least two SIBs is different.

In an embodiment, the SIB may be a SIB of a new version, which may be, for example, a SIB of SIB N, where Nis an integer greater than 21.

In the step S82, the base station sends the SI to the UE based on a first period, and the first period is the minimum period of the transmission periods of the at least two SIBs configured in the SI.

In an embodiment, a transmission period of any one of the at least two SIBs configured in the SI is a first multiple of the minimum period, and the first multiple is an integer greater than 0.

In the step S83, the UE receives the SI which sent by the base station based on the first period.

### EXAMPLE 2

Embodiments of the present disclosure provide a method for transmitting system information, which is performed by a communication device, and the communication device includes a base station and a UE. The method includes steps S91 to S93.

In the step S91, the base station configures at least two SIBs for one SI, state

information of broadcast states of the at least two SIBs is different, and the state information includes broadcast state information or non-broadcast state information.

In an embodiment, the SIB may be a SIB of a new version, which may be, for example, a SIB of SIB N, where Nis an integer greater than 21.

In the step S92, the base station sends the SI to the UE based on a first period, and the first period is the minimum period of the transmission periods of the at least two SIBs configured in the SI.

In an embodiment, a transmission period of any one of the at least two SIBs configured in the SI is a first multiple of the minimum period, and the first multiple is an integer greater than 0.

In an embodiment, the UE sends a DCI that schedules the SI, and an information field of the DCI indicates a scheduling status of a SIB type.

In the step S93, the UE receives the SI which sent by the base station based on the first period.

In an embodiment, the method includes step S64, and the step S64 includes: the UE receives the DCI that schedules the SI, and determines, based on a bit in the information field of the DCI, the scheduling status of the SIB type of the SIB configured in the SI.

For example, the base station configures 4 SIBs for one SI, and the 4 SIBs may be SIB 22, SIB 23, SIB 24 and SIB 25, respectively. There are 4 bits in the reserved information field of DCI 1-0 that schedules the SI, which are configured to indicate the SIB type actually transmitted in the scheduled SI, and one bit indicates a scheduling status of one SIB type. The UE receives the DCI 1-0, and if it is determined that the 4 bits in the reserved information field of DCI 1-0 are “1100”, it is determined that SIB22 and SIB23 are scheduled, and SIB24 and SIB 25 are not scheduled.

For example, the base station configures 4 SIBs for one SI, and the 4 SIBs may be SIB 22, SIB 23, SIB 24 and SIB 25, respectively. There are 2 bits in the reserved information field of DCI 1-0 that schedules the SI, which are configured to indicate the SIB type actually transmitted in the scheduled SI, and one bit indicates a scheduling status of two SIB types. The UE receives the DCI 1-0, and if it is determined that the 2 bits in the reserved information field of DCI 1-0 are “10”, it is determined that SIB22 and SIB23 are scheduled, and SIB24 and SIB 25 are not scheduled.

It should be noted that those skilled in the art can understand that the method provided in embodiments of the present disclosure can be executed alone or together with some methods in the embodiments of the present disclosure or some methods in the related arts.

As shown in FIG. 8, embodiments of the present disclosure provide an apparatus for transmitting system information, which is applied to a base station, and includes:
a sending module 61, configured to send a SI, at least two SIBs are configured in one SI, and at least one piece of characteristic information of the at least two SIBs is different.

In some embodiments, the characteristic information includes at least one of:
period information of a SIB transmission period; or
state information of a SIB broadcast state, and the state information includes: broadcast state information or non-broadcast state information.

Embodiments of the present disclosure provide an apparatus for transmitting system information, which is applied to a base station, and includes: a sending module 61, configured to send a SI, at least two SIBs are configured in one SI, and period information of the at least two SIBs is different.

Embodiments of the present disclosure provide an apparatus for transmitting system information, which is applied to a base station, and includes: a sending module 61, configured to send a SI, at least two SIBs are configured in one SI, and state information of the at least two SIBs is different.

Embodiments of the present disclosure provide an apparatus for transmitting system information, which is applied to a base station, and includes: a sending module 61, configured to send a SI, at least two SIBs are configured in one SI, and state information of the at least two SIBs is different and period information of the at least two SIBs is different.

In some embodiments, the SIB includes, but is not limited to, at least one of:
a predetermined SIB;
SIB N, where N is a positive integer; and
a SIB other than SIB 1 to SIB 21 and SIBpos.

Embodiments of the present disclosure provide an apparatus for transmitting

system information, which is applied to a base station, and includes a sending module 61, configured to send a SI based on a first period, and the first period is the minimum period among transmission periods of the at least two SIBs configured in the SI.

In some embodiments, a transmission period of any one of the at least two SIBs configured in the SI is a first multiple of the minimum period, and the first multiple is an integer greater than 0.

In some embodiments, a reserved information field of Downlink Control Information (DCI) that schedules the SI indicates a SIB type of a scheduled SIB in the SI.

In some embodiments, a bit of the reserved information field is configured to indicate a scheduling status of at least one SIB type.

In some embodiments, first indication information is carried in the bit to indicate that the SIB type is scheduled, or second indication information is carried in the bit to indicate that the SIB type is not scheduled.

As shown in FIG. 9, embodiments of the present disclosure provide an apparatus for transmitting system information, which is applied to a UE and includes:
a receiving module 71, configured to receive a System Information (SI), at least two System Information Blocks (SIBs) are configured in one SI, and at least one piece of characteristic information of the at least two SIBs is different.

In some embodiments, the characteristic information includes but is not limited to at least one of:
period information of a SIB transmission period; or
state information of a SIB broadcast state, and the state information includes: broadcast state information or non-broadcast state information.

In some embodiments, the SIB includes at least one of:
a predetermined SIB;
SIB N, where N is a positive integer; and
a SIB other than SIB 1 to SIB 21 and SIBpos.

Embodiments of the present disclosure provide an apparatus for transmitting system information, which is applied to a UE and includes:
a receiving module 71, configured to receive a SI which is sent based on a first period, and the first period is a minimum period among transmission periods of the at least two SIBs configured in the SI.

In some embodiments, the transmission period of any one of the at least two SIBs configured in the SI is a first multiple of the minimum period, and the first multiple is an integer greater than 0.

Embodiments of the present disclosure provide an apparatus for transmitting system information, which is applied to a UE, and includes: a receiving module 71, configured to determine, based on a reserved information field of Downlink Control Information (DCI) that schedules the SI, a SIB type of a scheduled SIB in the SI.

In some embodiments, a bit of the reserved information field is configured to indicate a scheduling status of at least one SIB type.

Embodiments of the present disclosure provide an apparatus for transmitting system information, which is applied to a UE, and includes: a receiving module 71, configured to, in response to the bit of the reserved information field carrying first indication information, determine that a SIB type indicated by the bit is scheduled.

Embodiments of the present disclosure provide an apparatus for transmitting system information, which is applied to a UE, and includes: a receiving module 71, configured to, in response to the bit of the reserved information field carrying second indication information, determine that a SIB type indicated by the bit is not scheduled.

It should be noted that those skilled in the art can understand that the apparatus provided in embodiments of the present disclosure can be executed alone or together with some apparatuses in the embodiments of the present disclosure or some apparatuses in the related arts.

Regarding the apparatus in the above embodiments, the specific manner in which each module performs operations has been described in detail in the embodiments of the method, and will not be elaborated here.

Embodiments of the present disclosure provide a communication device, including:
a processor; and
a memory configured to store executable instructions of the processor,
the processor is configured to implement the method for transmitting the system information in any embodiment of the present disclosure when running the executable instructions.

In an embodiment, the communication device may include but is not limited to at least one of the base station and the UE.

The processor may include various types of storage mediums, which are non-transitory computer storage mediums that can continue to remember information stored thereon after the UE loses power.

The processor can be connected to the memory via a bus, etc., and is configured to read the executable program stored in the memory, for example, at least one of the methods shown in FIGS. 2 to 7.

Embodiments of the present disclosure further provide a computer storage medium having a computer executable program stored thereon, which, when executed by a processor, implements the method for transmitting the system information in any embodiment of the present disclosure, for example, at least one of the methods shown in FIGS. 2 to 7.

Regarding the apparatus or storage medium in the above embodiments, the specific manner in which each module performs the operation has been described in detail in the method embodiments, and will not be elaborated here.

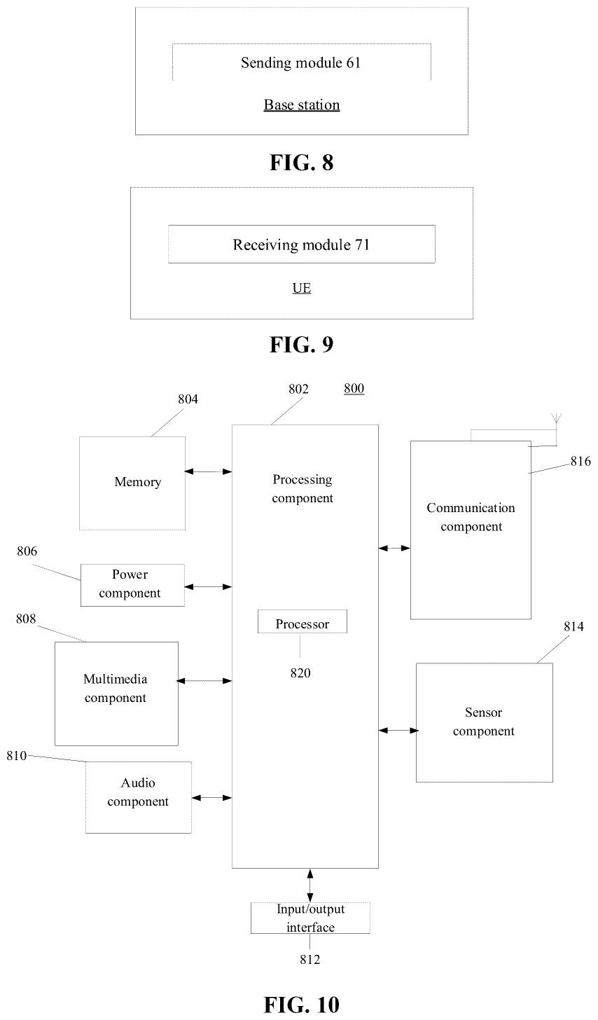

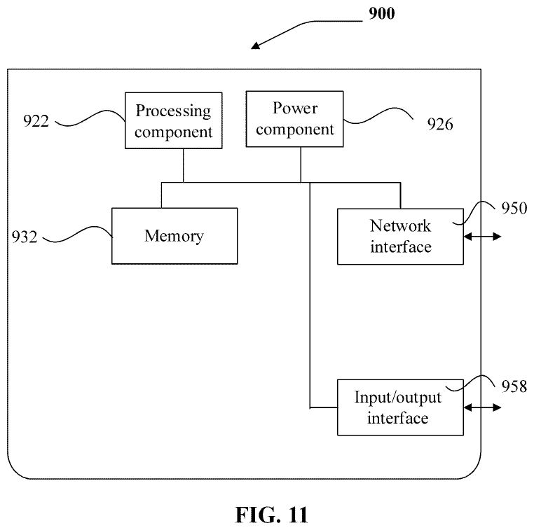

FIG. 10 shows a block diagram of a UE 800 according to an embodiment of the present disclosure. For example, the UE 800 may be a mobile phone, a computer, a digital broadcast terminal, a messaging device, a gaming console, a tablet device, a medical device, an exercise device, a personal digital assistant, etc.

Referring to FIG. 10, the UE 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the UE 800, such as the operations associated with display, telephone calls, data communications, camera operations, and recording operations. The processing component 802 may include one or more processors 820 to execute instructions to complete all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the UE 800. Examples of such data include instructions for any applications or methods operated on the UE 800, contact data, phonebook data, messages, pictures, video, etc. The memory 804 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the UE 800. The power component 806 may include a power management system, one or more power sources, and any other components associated with the generation, management, and distribution of power in the UE 800.

The multimedia component 808 includes a screen providing an output interface between the UE 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a duration and a pressure associated with the touch or swipe action. In some embodiments, the multimedia component 808 includes a front camera and/or a rear camera. The front camera and the rear camera may receive an external multimedia datum while the UE 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (MIC) configured to receive an external audio signal when the UE 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide state assessments of various aspects of the UE 800. For instance, the sensor component 814 may detect an open/closed state of the UE 800, relative positioning of components, e.g., the display and the keypad, of the UE 800, a change in position of the UE 800 or a component of the UE 800, a presence or absence of user contact with the UE 800, an orientation or an acceleration/deceleration of the UE 800, and a change in temperature of the UE 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the UE 800 and other devices. The UE 800 may access a wireless network based on a communication standard, such as WiFi, 4G or 5G, or a combination thereof. In an embodiment, the communication component 816 receives a broadcast signal or broadcast associated information from an external broadcast management system via a broadcast channel. In an embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment of the present disclosure, the UE 800 may be implemented with one or more application specific integrated circuits (ASICs), digital signal processors (DSPs), digital signal processing devices (DSPDs), programmable logic devices (PLDs), field programmable gate arrays (FPGAs), controller, micro-controller, microprocessors, or other electronic components, for performing the above described methods.

In an embodiment of the present disclosure, there is further provided a non-transitory computer readable storage medium including instructions, such as the memory 804 including instructions, the above instructions may be executed by the processor 820 in the UE 800 for completing the above-described methods. For example, the non-transitory computer-readable storage medium may be a ROM, a Random Access Memory (RAM), a CD-ROM, a magnetic tape, a floppy disc, an optical data storage device, and the like.

As shown in FIG. 11, embodiments of the present disclosure provide a structure of a base station. For example, a base station 900 may be provided as a network side device. Referring to FIG. 11, the base station 900 includes a processing component 922, which further includes one or more processors and a memory resource represented by a memory 932 for storing instructions executable by the processing component 922, such as an application program. The application program stored in the memory 932 may include one or more modules, each corresponding to a set of instructions. In addition, the processing component 922 is configured to execute the instructions to execute the aforementioned any method applied on the base station.

The base station 900 may further include: a power component 926 configured to perform power management of the base station 900, a wired or wireless network interface 950 configured to connect the base station 900 to the network, and an input/output (I/O) interface 958. The base station 900 may operate an operating system stored in the memory 932, such as Windows Server™, Mac OS X™, Unix™, Linux™, FreeBSD™, or the like.

Other implementations of the present disclosure will be apparent to those skilled in the art from consideration of the specification and practice of the present disclosure disclosed here. The present disclosure is intended to cover any variations, uses, or adaptations of the present disclosure following the general principles thereof and including the common general knowledge or habitual technical means in the technical field not disclosed in the present disclosure. The specification and embodiments are considered as exemplary only, and a true scope and spirit of the present disclosure is indicated by the appending claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. A method for transmitting system information, performed by a base station, and comprising:
sending a System Information (SI), wherein at least two System Information Blocks (SIBs) are configured in one SI, and wherein at least one piece of characteristic information of the at least two SIBs is different.

2. The method according to claim 1, wherein the characteristic information comprises at least one of:
period information of a SIB transmission period; or
state information of a SIB broadcast state, wherein the state information comprises: broadcast state information or non-broadcast state information.

3. The method according to claim 1, wherein a SIB of the at least two SIBs comprises at least one of:
a predetermined SIB;
SIB N, wherein N is a positive integer; and
a SIB other than SIB 1 to SIB 21 and SIBpos.

4. The method according to claim 1, wherein sending the SI comprises:
sending the SI based on a first period, wherein the first period is a minimum period among transmission periods of the at least two SIBs configured in the SI.

5. The method according to claim 4, wherein a transmission period of any one of the at least two SIBs configured in the SI is a first multiple of the minimum period, and the first multiple is an integer greater than 0.

6. The method according to claim 1, wherein a reserved information field of Downlink Control Information (DCI) that schedules the SI indicates a SIB type of a scheduled SIB in the SI.

7. The method according to claim 6, wherein a bit of the reserved information field is configured to indicate a scheduling status of at least one SIB type.

8. The method according to claim 7, wherein first indication information is carried in the bit to indicate that the SIB type is scheduled, or second indication information is carried in the bit to indicate that the SIB type is not scheduled.

9. A method for transmitting system information, performed by a User Equipment (UE), and comprising:
receiving a System Information (SI), wherein at least two System Information Blocks (SIBs) are configured in one SI, and wherein at least one piece of characteristic information of the at least two SIBs is different.

10. The method according to claim 9, wherein the characteristic information comprises at least one of:
period information of a SIB transmission period; or
state information of a SIB broadcast state, wherein the state information comprises: broadcast state information or non-broadcast state information.

11. The method according to claim 9, wherein a SIB of the at least two SIBs comprises at least one of:
a predetermined SIB;
SIB N, wherein N is a positive integer; and
a SIB other than SIB 1 to SIB 21 and SIBpos.

12. The method according to claim 9, wherein receiving the comprises:
receiving the SI which is sent based on a first period, wherein the first period is a minimum period among transmission periods of the at least two SIBs configured in the SI.

13. The method according to claim 12, wherein a transmission period of any one of the at least two SIBs configured in the SI is a first multiple of the minimum period, and the first multiple is an integer greater than 0.

14. The method according to claim 9, wherein the method comprises:
determining, based on a reserved information field of Downlink Control Information (DCI) that schedules the SI, a SIB type of a scheduled SIB in the SI.

15. The method according to claim 14, wherein a bit of the reserved information field is configured to indicate a scheduling status of at least one SIB type.

16. The method according to claim 15, wherein determining, based on the reserved information field of the Downlink Control Information (DCI) that schedules the SI, the SIB type of the scheduled SIB in the SI comprises:
in response to the bit of the reserved information field carrying first indication information, determining that a SIB type indicated by the bit is scheduled; or
in response to the bit of the reserved information field carrying second indication information, determining that the SIB type indicated by the bit is not scheduled.

17-18. (canceled)

19. A communication device, comprising:
a processor; and
a memory configured to store executable instructions of the processor;
wherein the processor is configured to implement the following operations when running the executable instructions:
sending a System Information (SI), wherein at least two System Information Blocks (SIBs) are configured in one SI, and wherein at least one piece of characteristic information of the at least two SIBs is different.

20. A non-transitory computer storage medium having a computer executable program stored thereon, wherein the executable program, when executed by a processor, implements the method for transmitting the system information according to claim 1.

21. A communication device, comprising:
a processor; and
a memory configured to store executable instructions of the processor;
wherein the processor is configured to implement he method for transmitting the system information according to claim 9 when running the executable instructions.

22. A non-transitory computer storage medium having a computer executable program stored thereon, wherein the executable program, when executed by a processor, implements the method for transmitting the system information according to claim 9.
